(19) United States
(12) Patent Application Publication
(10) Pub. No.: US 2010/0053548 A1
(43) Pub. Date: Mar. 4, 2010

(54) Toric Contact Lenses

(76) Inventors: Jose L. Perez, Jacksonville, FL (US); Timothy A. Clutterbuckl, Jacksonville, FL (US); Robert Boyd, Jacksonville, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/199,850

(22) Filed: Aug. 28, 2008

(51) Int. Cl. G02C 7/04

(52) U.S. Cl. 351/160 H

(57) ABSTRACT

The invention provides a toric lens having back surface toric correction that does not result in increased corneal staining. More specifically, the back surface toric optic zone of the lens of the invention is equal to or greater than about 50% of the entire back surface area.

### FIELD OF THE INVENTION

The invention relates to contact lenses. In particular, the invention provides contact lenses for the correction of astigmatism in which the correction is on the back surface of the lens.

### BACKGROUND OF THE INVENTION

It is known that correction of certain optical defects can be accomplished by imparting non-spherical corrective characteristics to one or more surfaces of a contact lens. One such type of correction is cylindrical correction to correct for the astigmatism of the eye of the lens wearer. However, the use of these lenses is problematic in that the lens must be maintained at a specific orientation while on the eye to be effective. When the lens is first placed on-eye, it must automatically position, or auto-position, itself and then maintain that position over time. But, once the lens is positioned, it tends to rotate on the eye due to blinking as well as eyelid and tear fluid movement.

Maintenance of the on-eye orientation of a lens typically is accomplished by altering the mechanical characteristics of the lens. For example, prism stabilization, including without limitation decentering of the lens' front surface relative to the back surface, thickening of the inferior lens periphery, forming depressions or elevations on the lens' surface, and truncating the lens edge, has been used.

Additionally, dynamic stabilization has been used in which the lens is stabilized by the use of thin zones, or areas in which the thickness of the lens' periphery is reduced. Typically, the thin zones are located at two symmetrically lying regions, one each on the superior and inferior regions of the lens periphery. A disadvantage of dynamic stabilization is that, when a dynamically stabilized lens is first placed on the eye, the lens may take between 10 and 20 minutes to auto-position itself.

Improved stabilization designs are known. However, depending upon the design of the back optic zone of lenses incorporating those stabilization designs, unwanted and excessive force on the cornea may result.

### BRIEF DESCRIPTION OF THE DRAWINGS

FIG. 1 is a plan view of a back surface of a lens of the invention.

### DETAILED DESCRIPTION OF THE INVENTION AND PREFERRED EMBODIMENTS

It is a discovery of the invention that a toric lens having back surface toric correction that does not result in increased corneal staining may be achieved by providing a back surface optic zone with certain parameters. More specifically, it is a discovery of the invention that by using a back surface toric optic zone that is equal to or greater than about 50% of the entire back surface area, pressure exerted by the lens on the cornea and, thus, corneal staining will be reduced. The back surface design of the invention may be useful in a wide variety of toric lenses, but may find particular utility in soft toric lenses made from silicone hydrogel lenses and most particularly in silicone hydrogel lenses using any one of the stabilization designs of U.S. Pat. Nos. 6,939,005; 7,036,930; and 7,159,979 incorporated herein in their entireties by reference.

In one embodiment the invention provides a soft contact lens comprising, consisting essentially of, and consisting of a back surface having a toric optic zone, wherein the toric optic zone is equal to or greater than about 50% of a total back surface area.

By “back surface” is meant the surface of the lens that, when the lens is on-eye, is the closest to the surface of the eye.

By “total back surface area” is meant the entire area of the back surface excluding the lens edge. For example, the total back surface includes the optical and non-optical portion of the back surface, excluding the lens edge. The lens edge is the outermost portion of the lens relative to the lens' geometric center. Typically, the lens edge is about 0.02 mm to about 0.2 mm in width.

It is a discovery of the invention that the pressure exerted on the lens surface by the toric back surface of a contact lens may be decreased by enlarging the back surface optic zone to be equal to or greater than about 50% of the total back surface area. Preferably, the lenses of the invention have a diameter of from about 13.5 to about 15.5, and more preferably about 14.5, mm.

A toric optic zone will have two diameters; a long and a short diameter. In the lenses of the invention, the back surface optical zone is preferably at least about 10 to 14 mm, and more preferably 13 mm, in the long diameter of the torus and between about 8.5 to 12.5 mm in its short diameter.

In a still more preferred embodiment, a fillet curve is used to blend the optic and non-optic zones of the lens. The preferred radius, meaning the radius relative to the origin of the arc of the fillet, of the fillet zone is 50 to about 500 mm and more preferably is about 260 mm.

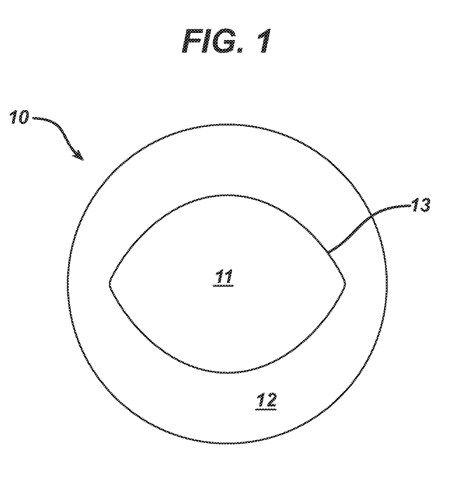

In FIG. 1 is depicted a back surface of a lens 10 of the invention. The back surface has a toric optic zone 11 and a non-optic zone 12. Fillet curve 13 blending the optic and non-optic zone is also shown.

In a preferred embodiment, in addition to the above-described back surface optic zone, the lenses of the invention incorporate a specific thickness differential. By “thickness differential” is meant the difference in thickness between the thickest and thinnest points of the lens' periphery. Thickness at a given point on the lens is measured in terms of the distance between the front, or object side, surface and back surface of the lens along a direction orthogonal to the back surface. The thickness differential of the lens periphery in the lenses of the invention is about 200 to about 400, preferably about 240 to about 300 μm. By “lens periphery” is meant the non-optical portion of the lens that lies adjacent to and surrounds the optic zone and excludes the lens edge.

In a preferred embodiment, a front, or object side, surface of the lens has an optic zone surrounded by a lens periphery composed of four regions; two thin zones or regions and two thick zones or regions. In the two thin zones, the thickness of the lens periphery is reduced as compared to the remainder of the lens periphery or regions. The thin zones preferably are located at the superior, or top, and inferior, or bottom portions of the lens periphery, respectively. More preferably, the superior and inferior thin zones are symmetrical about the 90 and 270 degree points, respectively. Additionally, two thick regions, which regions are the two thickest regions of the lens periphery. These regions preferably lie at opposing ends of the horizontal axis, or 0-180 degree axis and preferably, one region is symmetrical about the 0 degree and one is symmetrical about the 180 degrees point of the lens' periphery.

Each of the thin zones can be viewed as having two points along the y-axis, outermost point along the outermost edge of the thin zone that is farthest from the lens' geometric center and inner-most point along the innermost edge and that is nearest the lens' geometric center. As one moves along the y-axis away from the outermost edge and point inwardly toward the inner-most point, preferably there is a continuous increase in the thickness of the thin zone. The change in the thickness as one moves vertically along the y-axis of the thin zone toward the geometric center of the lens may be linear. This thickness change may be represented by the following equation:

T=f(y) (I)

wherein T is the thickness; and
f(y) is a function of the thickness change as one moves along the y-axis.

Alternatively, the thickness change may be accelerated, or non-linear, and according to the equation:

T=g(y) (II)

wherein T is the thickness; and
g(y) is a function of the thickness change as one moves along the y-axis.

One ordinarily skilled in the art will recognize that, for each of Equations I and II, cartesian, or polar coordinates may be used. Additionally, it will be recognized that Equations I and II may represent any of a large number of functions. A preferred function for Equation I is:

$$T = {T}_{max} - ( y - {y}_{0} ) \frac{( {T}_{max} - {T}_{min} )}{( {y}_{1} - {y}_{0} )} \qquad ( III )$$

wherein Tₘₐₓ is the maximum thickness at y=y₀;
Tₘᵢₙ is the minimum thickness at y=y₁;
y is the function variable; and
y₀ and y₁ are points along the y axis.

An alternative preferred function for Equation I, in polar coordinates, is as follows:

$$T = {T}_{max} - ( r - {r}_{0} ) \frac{( {T}_{max} - {T}_{min} )}{( {r}_{1} - {r}_{0} )} \qquad ( IV )$$

wherein Tₘₐₓ is the maximum thickness at r=r₀;
Tₘᵢₙ is the minimum thickness at r=r₁;
r is the function variable; and
r₀ and r₁ are points along the r axis.

A preferred function for Equation II is:

$$T = {T}_{min} + {T}_{d} {cos [ \frac{π ( y - {y}_{0} )}{2 \cdot ( {y}_{1} - {y}_{0} )} ]}^{α} \qquad ( V )$$

wherein Tₘᵢₙ is the minimum thickness at y=y₁;
(Tₘᵢₙ+T_{d}) is the maximum thickness at y=y₀;
α is coefficient that controls the shape of the transition in thickness from Tₘᵢₙ to (Tₘᵢₙ+T_{d}); and
y₀ and y₁ are points along the y axis.

The invention may also find utility in toric multifocal lenses. Multifocal lenses include, without limitation, bifocal and progressive lenses. One type of bifocal lens provides a back surface with a toric optic zone and a front surface optic zone with either a progressive power profile of near optical power to distance optical power, or the reverse, or annular rings alternating between near and distance optical power. By “near optical power” is meant the amount of refractive power required to correct the wearer's near vision acuity to the desired degree. By “distance optical power” is meant the amount of refractive power required to correct the wearer's distance vision acuity to the desired degree.

As yet another alternative, the lenses of the invention may incorporate correction for higher order ocular aberrations, corneal topographic data, or both. Examples of such lenses are found in U.S. Pat. Nos. 6,305,802 and 6,554,425 incorporated herein by reference in their entireties.

The lenses of the invention may be made from any suitable contact lens forming materials and preferably are made from one or more soft contact lens material. Illustrative materials for formation of soft contact lenses include, without limitation silicone elastomers, silicone-containing macromers including, without limitation, those disclosed in U.S. Pat. Nos. 5,371,147, 5,314,960, and 5,057,578 incorporated in their entireties herein by reference, hydrogels, silicone-containing hydrogels, and the like and combinations thereof. More preferably, the surface is a siloxane, or contains a siloxane functionality, including, without limitation, polydimethyl siloxane macromers, methacryloxypropyl polyalkyl siloxanes, and mixtures thereof, silicone hydrogel or a hydrogel, such as etafilcon A.

A preferred contact lens material is a poly 2-hydroxyethyl methacrylate polymers, meaning, having a peak molecular weight between about 25,000 and about 80,000 and a polydispersity of less than about 1.5 to less than about 3.5 respectively and covalently bonded thereon, at least one cross-linkable functional group. This material is described in U.S. Ser. No. 60/363,630 incorporated herein in its entirety by reference. More preferably, the lens material for the lenses of the invention are one or both of galyfilcon A and senofilcon A.

Curing of the lens material may be carried out by any convenient method. For example, the material may be deposited within a mold and cured by thermal, irradiation, chemical, electromagnetic radiation curing and the like and combinations thereof. Preferably, for contact lens embodiments, molding is carried out using ultraviolet light or using the full spectrum of visible light. More specifically, the precise conditions suitable for curing the lens material will depend on the material selected and the lens to be formed. Suitable processes are disclosed in U.S. Pat. No. 5,540,410 incorporated herein in its entirety by reference.

The contact lenses of the invention may be produced by any convenient method. One such method uses an OPTOFORM™ lathe with a VARIFORM™ attachment to produce mold inserts. The mold inserts in turn are used to form molds. Subsequently, a suitable liquid resin is placed between the molds followed by compression and curing of the resin to form the lenses of the invention. One ordinarily skilled in the art will recognize that any number of known methods may be used to produce the lenses of the invention.

What is claimed is:

1. A soft contact lens, comprising a back surface having a toric optic zone, wherein the toric optic zone is equal to or greater than about 50% of a total back surface area.

2. The lens of claim 1, wherein a diameter of the lens is from about 13.5 to about 15.5 and a first diameter of the back surface optic zone is between about 10 and 14 mm and a second diameter of the back surface optic zone is about 8.5 to 12.5 mm.

3. The lens of claim 1, further comprising a fillet curve between the toric optic zone and a non-optic zone of the back surface.

4. The lens of claim 2, further comprising a fillet curve between the toric optic zone and a non-optic zone of the back surface.

5. The lens of claim 1, wherein the lens further comprises galyfilcon A.

6. The lens of claim 2, wherein the lens further comprises galyfilcon A.

7. The lens of claim 3, wherein the lens further comprises galyfilcon A.

8. The lens of claim 4, wherein the lens further comprises galyfilcon A.

9. The lens of claim 1, wherein the lens further comprises senofilcon A.

11. The lens of claim 2, wherein the lens further comprises senofilcon A.

12. The lens of claim 3, wherein the lens further comprises senofilcon A.

13. The lens of claim 4, wherein the lens further comprises senofilcon A.

14. A method of reducing corneal staining, comprising providing a soft contact lens comprising a back surface having a toric optic zone, wherein the toric optic zone is equal to or greater than about 50% of a total back surface area.

15. A method of reducing corneal staining, comprising providing a soft contact lens comprising one or both of galyfilcon A and senofilcon A and a back surface having a toric optic zone, wherein the toric optic zone is equal to or greater than about 50% of a total back surface area.
